(19) United States
(12) Patent Application Publication
(10) Pub. No.: US 2023/0393528 A1
(43) Pub. Date: Dec. 7, 2023

(54) HOROLOGICAL REGULATING MEMBER PROVIDED WITH AN INDEX-ASSEMBLY SYSTEM

(71) Applicant: ETA SA Manufacture Horlogère Suisse, Grenchen (CH)

(72) Inventors: Jean-Luc HELFER, Le Landeron (CH); Olivier MERTENAT, Grenchen (CH); Ivan VILLAR, Brügg (CH); Dominique LECHOT, Les Reussilles (CH)

(73) Assignee: ETA SA Manufacture Horlogère Suisse, Grenchen (CH)

(21) Appl. No.: 18/315,670

(22) Filed: May 11, 2023

(30) Foreign Application Priority Data
Jun. 2, 2022 (EP) 22177059.7

(51) Int. Cl. G04B 18/06; G04B 18/00

(52) U.S. Cl. CPC G04B 18/06; G04B 18/006

(57) ABSTRACT

A regulating member for a horological movement including an inertial mass, for example an annular balance, a balance spring, and an index-assembly system for adjusting the rate of the balance spring, the balance spring including a coiled strip and a device for adjusting the stiffness of the balance spring, which are provided with a resilient element arranged in series with the coiled strip, the index-assembly system including a stud-holder including a first stud and a second stud, wherein the resilient element is arranged between the first stud and the second stud, the first stud being capable of moving relative to the second stud, the movement of the first stud changing the stiffness of the balance spring.

### TECHNICAL FIELD OF THE INVENTION

The invention relates to the field of horology, and more particularly to the field of mechanical horology, where the motive energy is regulated by a regulating member. The invention relates, more specifically, to a regulating member provided with an index-assembly system, a horological movement comprising such a regulating member, and a timepiece comprising such a horological movement.

### TECHNOLOGICAL BACKGROUND

In most mechanical watches, the energy required to rotate the hands (for example the minute and hour hands) is stored in a barrel and then delivered by a sprung balance system, which comprises a flywheel referred to as a balance, associated with a spring in the form of a spirally-coiled strip, referred to as a balance spring.

At an inner end, the balance spring is fixed to a staff which is integral with the balance rotation therewith; at an outer end, the balance spring is fixed to a stud mounted on a stud-holder which is itself integral with a fixed cock (or bridge).

The rotation of the balance is maintained—and its oscillations counted—by an escapement mechanism comprising a pallet-lever caused to move by an oscillating motion of low amplitude, provided with two pallet-stones which act against the teeth of an escape wheel. Thus impacted, the escape wheel is given a step-by-step rotational motion, the frequency whereof is determined by the frequency of oscillation of the pallet-lever, which is itself set to the frequency of oscillation of the sprung balance.

In a conventional escapement mechanism, the oscillation frequency is about 4 Hz, or about 28,800 vibrations per hour (vph). One goal of good watchmakers is to guarantee the isochronism and regularity of the oscillations (or constancy of rate) of the balance.

The rate of the balance is regulated in a known manner by adjusting the active length of the balance spring, defined as the curvilinear length between its inner end and a count point, located in the vicinity of the outer end of the balance spring and typically defined by a pair of bankings carried by a key mounted on an index-assembly system.

During operation, this index-assembly system is fixed such that it rotates relative to the axis of the balance spring. However, the angular position can be finely adjusted by manual intervention, for example by using a screwdriver to pivot an eccentric, which acts like a cam on the index-assembly system.

The assembly comprising the cock, the index-assembly system, the key, the stud-holder, the staff, the spring and the balance is commonly referred to as the “regulating member”. Examples of regulating members are proposed by the international patent application No. 2016/192957 and by the European patent No. 2 876 504, both filed by the watchmaker ETA.

Index-assembly systems including a stud-holder exist, to which one end of the balance spring is fixed, and where the index-assembly system key leaves play to allow the balance spring to move between the two bankings. However, the chronometric properties, in particular the amplitude-dependent anisochronism, are very sensitive to the index key play, and yet this play is difficult to control with precision.

In some devices, the bankings can be adjusted to squeeze the balance spring and thus eliminate the play, in particular during operation of the balance spring. In such a case, the rate is firstly regulated by moving the index key, after which the balance spring is squeezed against the key. However, squeezing the balance spring against the index key can place it under strain and create chronometric defects, in particular by decentring the turns. Moreover, removing the play also changes the rate, and once the balance spring has been squeezed, the index key can no longer be moved along the balance spring to finish finely regulating the rate.

Other balance springs include an integrated regulator device. In these balance springs, the rate is not regulated by changing the effective length of the balance spring, but by applying a force or torque to a resilient element arranged in series with the balance spring. The stiffness of the resilient element and thus of the balance spring as a whole can thus be changed. The adjustment of the stiffness of the balance spring allows the rate of the regulating member to be regulated. Such a balance spring with a resilient element is, for example, described in the European patent application No. 21202213.1.

However, in such cases, the typical index-assembly systems cannot be used, as they are not compatible with the balance spring regulator device. Moreover, as the rate is very finely regulated, it is essential that there is no play between the balance spring and its areas of interaction with the index-assembly. This is because, conversely, there would be a risk of altering the rate in the event of an impact, if the balance spring does not reposition itself in exactly the same way after the impact.

### SUMMARY OF THE INVENTION

The purpose of the present invention is to overcome some or all of the aforementioned drawbacks by providing an index-assembly system that is compatible with this type of regulator device.

For this purpose, the invention relates to a regulating member for a horological movement comprising an inertial mass, for example an annular balance, a balance spring, and an index-assembly system for adjusting the rate of the balance spring, the balance spring comprising a coiled strip and means for adjusting the stiffness of the balance spring, which are provided with a resilient element arranged in series with the coiled strip.

The invention is noteworthy in that the index-assembly system comprises a stud-holder mechanically joined to the resilient element, the stud-holder including a first stud and a second stud, the resilient element being arranged between the first stud and the second stud, the first stud being capable of moving relative to the second stud, the movement of the first stud changing the stiffness of the balance spring.

The invention provides an index-assembly system that is compatible with a balance spring regulator device that applies a force or torque to a resilient element of the balance spring.

More specifically, moving the first stud relative to the second stud changes the stiffness of the resilient element between the two studs, as a variable force or torque is applied to the resilient element by the two studs.

Moreover, such an index-assembly system is easy to use, and no major changes are required in order to assemble it on the horological movement because its assembly is not very different from that of an index-assembly system typically used for a conventional balance spring.

According to one specific embodiment of the invention, the stud-holder comprises a first part provided with the first stud, and a second part provided with the second stud, the first part being capable of moving relative to the second part in order to move the first stud.

According to one specific embodiment of the invention, the first part and the second part are superimposed.

According to one specific embodiment of the invention, the index-assembly system comprises a regulator means, such as an eccentric screw, which cooperates with the first part so as to move it as it rotates.

According to one specific embodiment of the invention, the index-assembly system comprises an arm arranged on the first part and a cam cooperating with the arm, such that the actuation of the cam moves the first part relative to the second part.

According to one specific embodiment of the invention, the index-assembly system comprises a return means, such as a spring, exerting a force between the first part and the second part to hold the arm of the first part against the cam.

According to one specific embodiment of the invention, the second part is unmoving relative to the plate.

According to one specific embodiment of the invention, the first part is capable of moving in rotation relative to the second part.

According to one specific embodiment of the invention, the first stud is capable of moving in rotation.

According to one specific embodiment of the invention, the balance spring comprises a coiled strip and means for adjusting the stiffness of the balance spring, the adjustment means comprising a resilient element, the resilient element being arranged between the first stud and the second stud, the movement of the first stud changing the stiffness of the resilient element.

According to one specific embodiment of the invention, the adjustment means comprise prestressing means for applying a variable force or torque to the flexible element, the prestressing means being arranged between the first stud and the second stud, the movement of the first stud relative to the second stud actuating the prestressing means.

According to one specific embodiment of the invention, the prestressing means include a lever connected to the flexible element, the first stud being integral with a free end of the lever.

According to one specific embodiment of the invention, the flexible element is joined to a fixed support, the second stud being integral with the fixed support.

According to one specific embodiment of the invention, the prestressing means include a semi-rigid structure arranged in parallel with the flexible element, the lever being connected to the semi-rigid structure.

The invention further relates to a horological movement comprising such a regulating member.

The invention further relates to a timepiece, for example a watch, comprising such a horological movement.

### BRIEF DESCRIPTION OF THE FIGURES

The purposes, advantages and features of the present invention will appear after reading several embodiments, which are provided for purposes of illustration only and not intended to limit the scope of the invention, given with reference to the accompanying drawings, in which:

FIG. 1 diagrammatically shows a perspective view of a regulating member according to a first embodiment of the invention, the regulating member being arranged inside a horological movement,

FIG. 2 diagrammatically shows a perspective view of a part of the first embodiment of the regulating member in FIG. 1, without the balance cock and without the index-assembly system,

FIG. 3 diagrammatically shows a top view of a balance spring of the regulating member,

FIG. 4 diagrammatically shows a perspective view of a part of a regulating member according to a second embodiment of the invention, the regulating member being arranged inside a horological movement, and

FIG. 5 diagrammatically shows a perspective view of the second embodiment of the regulating member in FIG. 4.

### DETAILED DESCRIPTION OF THE INVENTION

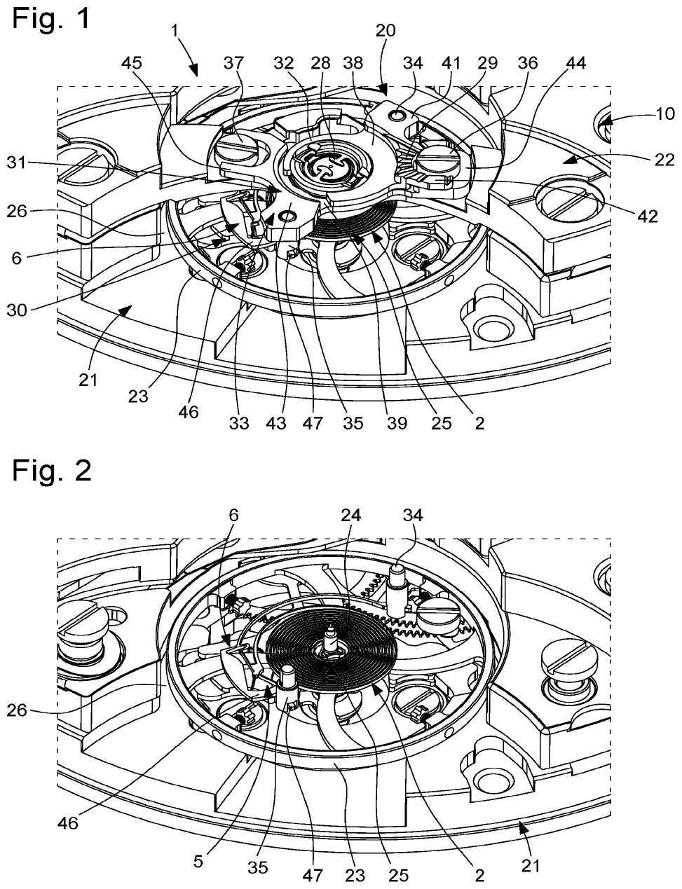

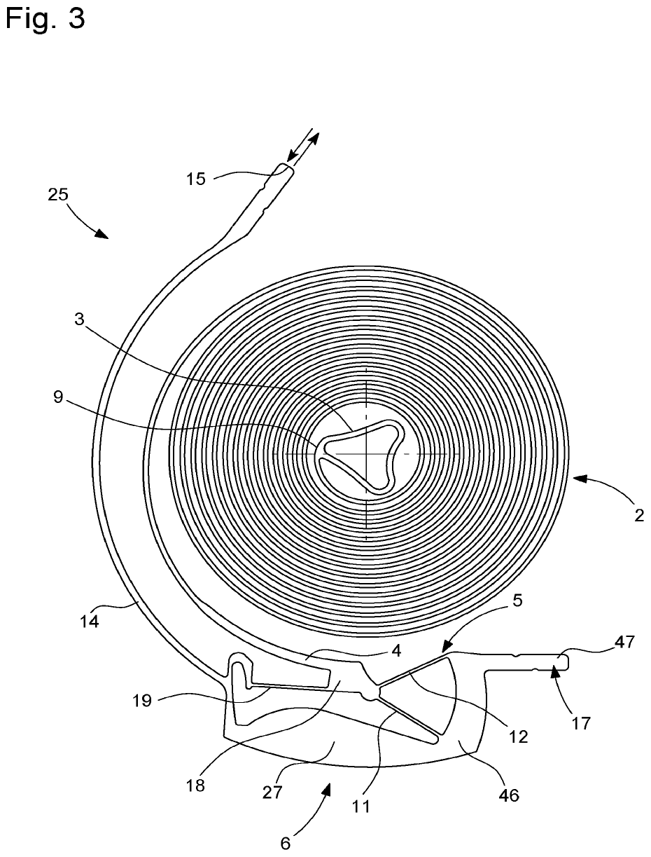

FIGS. 1 and 2 show a diagrammatic view of a first embodiment of a regulating member 1 arranged inside a horological movement 10. The horological movement 10 comprises a plate 21, an inertial mass, a resilient return element for the inertial mass configured to cause it to oscillate, and a balance cock 22.

The regulating member 1 further comprises an index-assembly system 20, an annular balance 23 acting as an inertial mass, a balance staff 24 and a balance spring 25 acting as a resilient return element.

The plate 21 is provided with a recess 26 for receiving the regulating member 1, inside which the balance 23, the balance spring 25, the balance cock 22 and the index-assembly system 20 are superimposed from the bottom upwards. The balance staff 24 is centred inside the recess 26 and passes through the centre of the balance 23, of the balance spring 25 and of the balance cock 22. The balance staff 24 is held by two shockproof bearings 28 arranged at the two ends of the balance staff 24. A first bearing is arranged at the bottom of the recess 26, and the second bearing 28 is arranged above the recess 26, and is held by the balance cock 22, the balance cock 22 passing through the top of the recess 26 through the central axis of the recess 26. The balance cock 22 has a through-hole inside which the second bearing 28 is held. The index-assembly system 20 is mounted on the balance cock 22 and is disposed along the central axis of the recess 26.

As shown in FIGS. 2 and 3, the balance spring 25 preferably extends substantially in one plane. The balance spring 25 comprises a flexible strip 2 coiled on itself in several turns, the strip 2 having a predefined rigidity. The inner end 9 of the strip 2 is formed integrally in one piece with or assembled with a support 3. The support 3 is substantially triangular in shape, and is threaded around the balance staff 24.

The balance spring 25 further includes means to adjust its rigidity. For example, the adjustment means can in particular be actuated by a user when the regulating member is mounted on the plate of the horological movement.

The adjustment means include a flexible element 5 arranged in series with the strip 2, the flexible element 5 connecting one end 4, 9 of said strip 2 to a fixed support 17, and integral with one of the ends 4, 9 of the strip 2. The flexible element 5 is integral with the outer end 4 of the strip 2. The resilient element 5 is a different element from the strip 2. The fixed support 17 is fixed relative to the plate 21.

The flexible element 5 adds additional rigidity to that of the strip 2. The flexible element 5 preferably has a higher rigidity than the strip 2. The flexible element 5 is, in this case, arranged in the continuation of the strip 2. Preferably, the adjustment means and the strip 2 are made in one piece, or are even made of the same material, for example silicon.

The flexible element 5 of the balance spring 25 comprises an uncrossed flexural pivot. The pivot comprises two flexible, uncrossing blades 11, 12 and a rigid part 18. The flexible blades 11, 12 are joined laterally to a fixed support 17 on the one hand, and to the rigid part 18 on the other hand by moving towards one another. Thus, preferably, the flexible blades 11, 12 move away from one another as they extend from the rigid part 18 towards the fixed support 17. The outer end 4 of the strip 2 is joined to the rigid part 18. The fixed support 17 is unable to move relative to the plate 21. The fixed support 17 is L-shaped, with a first arm 46 of the L acting as a connection to the flexible blades 11, 12, and the second arm 47 of the L facing away from the uncrossed pivot so that it can be assembled with the horological movement 10.

The means for adjusting the balance spring 25 further include prestressing means 6 for applying a variable force or torque to the flexible element 5. The rigidity of the balance spring can thus be adjusted. The torque or force can be continuously adjusted by the prestressing means 6. In other words, the torque or force is not restricted to point values. Thus, the rigidity of the flexible element 5 can be adjusted with high precision.

The prestressing means 6 include a secondary flexible blade 19, arranged on an opposite side of the rigid part 18 in the continuation of the uncrossed pivot. The secondary flexible blade 19 is disposed tangentially to the strip 2 at the outer end 4.

The secondary flexible blade 19 is connected at the other end to a curved lever 14 which runs around the strip 2. As well as being connected to the secondary flexible blade 19, the lever 14 is connected to a semi-rigid structure 27 joined to the fixed support 17. The semi-rigid structure 27 deforms in part when the lever 14 is actuated by the force or torque.

The force or torque is exerted on the free end 15 of the lever 14. Thus, the lever 14 of the prestressing means 6 transmits the force or torque to the flexible element 5 via the secondary flexible blade 19 and the semi-rigid structure 27, so as to modify the rigidity of the balance spring 25.

In order to be able to apply the variable force or torque to the balance spring 25, the regulating member comprises a specific index-assembly system 20 according to the invention.

In the first embodiment shown in FIGS. 1 and 2, the index-assembly system 20 is provided with a stud-holder 31 in two parts, a first part 32 and a second part 33. The first part 32 of the stud-holder 31 suspends the first stud 34, whereas a second part 33 of the stud-holder 31 is provided with the second stud 35. The stud-holder 31 is mechanically joined to the resilient element 5, but it does not block the strip 2.

The first part 32 of the stud-holder 31 is disposed partly above the second part 33 of the stud-holder 31, which is in contact with the balance cock 22. The index-assembly system 20 comprises two screws 36, 37. A first screw 36 is eccentric to allow angular adjustment between the two parts of the stud-holder 31. The first screw 36 passes through the first part 32 and the second part 33. A second screw 37 is used to fix the index-assembly system 20 to the balance cock 22.

The two parts 32, 33 surround the second bearing 28. For this purpose, each part 32, 33 comprises a central ring 38, 39 arranged around the second bearing 28, the two central rings 38, 39 being superimposed.

The first part 32 comprises two protrusions 41, 42 extending radially from the central ring 38, a first protrusion 41 holding the first stud 34 downwards inside the recess 26, the second protrusion 42 having an arc shape cooperating with the first screw 36.

The second part 33 comprises three protrusions 43, 44, 45 extending from the central ring 39. A first protrusion 43 holds the second stud downwards inside the recess 26, a second protrusion 44 extending around the first screw 36, and the third protrusion 45 having an arc shape cooperating with the second screw 37.

In a reference arrangement, the first stud 34 and the second stud 35 are, for example, arranged substantially symmetrically relative to the staff of the balance 24.

The first stud 34 cooperates with the free end 15 of the lever 14, and the second stud 35 cooperates with the second arm 47 of the fixed support 17. In this way, the prestressing means 6 and the resilient element 5 are supported by the index-assembly system 20 from which they are suspended.

The two studs 34, 35 are arranged on either side of the prestressing means 6 and of the resilient element 5. Moreover, the two studs 34, 35 are rigidly joined to the lever 14 and to the fixed support 17. In other words, the first stud 34 and the second stud 35 are respectively integral with the lever 14 and with the fixed support 17. The studs and the balance spring are, for example, assembled by bonding, brazing, welding, by metallic glass deformation, or by mechanical fastening.

The first stud 34 is capable of moving relative to the second stud 35. For this purpose, the first part 32 is capable of moving relative to the second part 33. The first part 32 is capable of moving in rotation about the second bearing 28. Thus, the first stud 34 moves with the first part 32, the first stud 34 being capable of moving in rotation about the second bearing 28. For example, the first stud 34 can be moved over an angular range of 20°, or of 10°.

The movement of the first stud 34 relative to the second stud 35 changes the stiffness of the resilient element 5, as the movement exerts a greater or lesser force or torque on the lever 14 of the prestressing means 6, such that the stiffness of the resilient element 5 varies, and thus the stiffness of the whole balance spring 25 varies. The index-assembly system 20 can thus be used to regulate the rate of the regulating member 1.

For this purpose, the regulating member 1 includes adjustment means 30 for changing the position of the first stud 34 relative to the second stud 35. The first stud 34 and the second stud 35 are connected to the adjustment means 30.

The adjustment means 30 comprise the second arc-shaped protrusion 42 of the first part 32 and the first eccentric screw 36. The arc of a circle has substantially the same diameter as the head of the first screw 36, such that movement of the first screw 36 causes the second protrusion 42, and thus the first part 32, to move relative to the second part 33 circularly about the second bearing 28, whereas the second part 33 remains in position, when the first part 32 is actuated. Thus, by rotating the first screw 36, the second arc-shaped protrusion 42 moves circularly about the second bearing 28. The first part 32 moves relative to the second part 33, and as a result, the first stud 34 moves relative to the second stud 35 to change the force or torque applied to the prestressing means 6 of the balance spring 25.

Regulation marks 29 are disposed on the second arc-shaped protrusion 42 around the first eccentric screw 36. Thus, to regulate the index-assembly system 20, the first screw 36 is oriented according to a preferential mark.

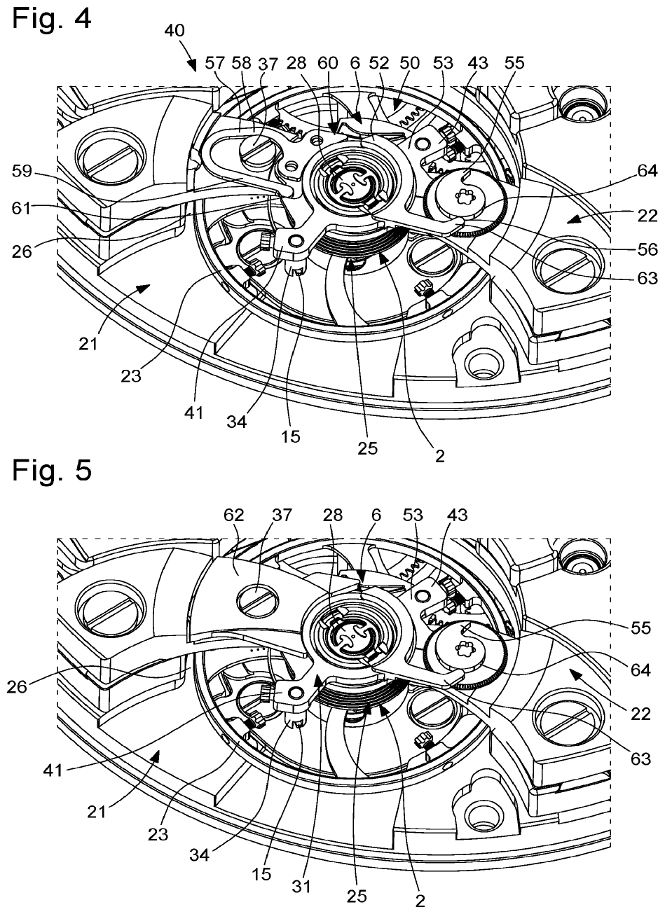

In the second embodiment of the regulating member 40 in FIGS. 4 and 5, the features of the regulating member 40 are substantially the same as in the first embodiment, except for the adjustment means 50 of the index-assembly system 60.

The first part 52 of the index-assembly system 60 comprises an arm 63 extending radially outwards from the first part 52 in a single plane. The second part 53 comprises two protrusions only, and does not comprise the arc-shaped protrusion cooperating with the second screw 37.

The adjustment means 50 include a cam 55 capable of moving in rotation in place of the first screw. The cam 55 cooperates with the arm 63 of the first part 52 to cause it to rotate about the second bearing 28. The end 56 of the arm 63 is constantly in contact with the cam 55, such that the rotation of the cam 55 exerts a movement on the arm 63 depending on the angular position of the cam 55. Thus, the first part 52 of the index-assembly system moves in a manner similar to that of the first embodiment. Such adjustment means 50 provided with a cam 55 allow the rigidity of the balance spring 25 to be varied linearly.

In order to maintain the arm 63 of the first part 52 in contact with the cam 55, the adjustment means 50 include a spring 57 exerting a return force on the first part 52. The spring 57 is substantially U-shaped surrounding the second screw 37, a first end 58 of the U being assembled with the second part 53 of the index-assembly system 20, and a second end 59 of the U being retained by a retaining hook 61 arranged on the first part 52. The spring 57 is arranged on the balance cock 22 symmetrically to the cam 55 relative to the second bearing 28. The spring 57 is covered by a cover 62 assembled on the balance cock 22 to hold it in place.

Thus, the spring 57 exerts a return force on the two parts 52, 53 of the index-assembly system 60, the return force being designed to constantly hold the arm 63 of the first part 52 in contact with the cam 55. When the cam is acted upon, the first part 52 rotates to move the first stud 34 relative to the second stud 35, while being subjected to a return force exerted by the spring 57, to allow the arm 63 of the first part 52 to come into contact with the cam 55, in particular when the peripheral wall 64 of the cam 55 moves away from the arm 63.

It goes without saying that the invention is not limited to the embodiments of regulating members described with reference to the figures and alternatives can be considered without leaving the scope of the invention.

1. A regulating member for a horological movement comprising an inertial mass, for example a balance, a balance spring, and an index-assembly system for adjusting the rate of the balance spring, the balance spring comprising a coiled strip and an adjustment device for adjusting the stiffness of the balance spring, which are provided with a resilient element arranged in series with the coiled strip, the index-assembly system comprising a stud-holder mechanically joined to the resilient element, the stud-holder including a first stud and a second stud, wherein the resilient element is arranged between the first stud and the second stud, the first stud being capable of moving relative to the second stud, the movement of the first stud changing the stiffness of the balance spring.

2. The regulating member according to claim 1, wherein the stud-holder comprises a first part provided with the first stud, and a second part provided with the second stud, the first part being capable of moving relative to the second part in order to move the first stud.

3. The regulating member according to claim 1, wherein the first part and the second part are superimposed.

4. The regulating member according to claim 1, wherein the index-assembly system comprises a regulator, such as an eccentric screw, which cooperates with the first part so as to move it as it is screwed/unscrewed.

5. The regulating member according to claim 1, wherein the index-assembly system comprises an arm arranged on the first part and a cam cooperating with the arm, such that the actuation of the cam moves the first part relative to the second part.

6. The regulating member according to claim 5, wherein the index-assembly system comprises a return device, such as a spring, exerting a force between the first part and the second part to hold the arm of the first part against the cam.

7. The regulating member according to claim 1, wherein the second part is unmoving relative to the plate.

8. The regulating member according to claim 1, wherein the first part is capable of moving in rotation relative to the second part.

9. The regulating member according to claim 1, wherein the first stud is capable of moving in rotation.

10. The regulating member according to claim 1, wherein the adjustment device comprise a prestressing device for applying a variable force or torque to the flexible element, the prestressing device being arranged between the first stud and the second stud, the movement of the first stud relative to the second stud actuating the prestressing device.

11. The regulating member according to claim 10, wherein the prestressing device include a lever connected to the flexible element, the first stud being integral with a free end of the lever.

12. The regulating member according to claim 10, wherein the flexible element is joined to a fixed support, the second stud being integral with the fixed support.

13. The regulating member according to claim 10, wherein the prestressing device include a semi-rigid structure arranged in parallel with the flexible element, the lever being connected to the semi-rigid structure.

14. A horological movement, wherein the horological movement comprises a regulating member according to claim 1.

15. A timepiece, for example a watch, wherein the timepiece comprises a horological movement according to claim 14.
